(19) United States
(12) Patent Application Publication
(10) Pub. No.: US 2026/0064731 A1
(43) Pub. Date: Mar. 5, 2026

(54) Smart RAG For Different Types Of Data

(71) Applicant: Oracle International Corporation, Redwood Shores, CA (US)

(72) Inventors: Amir Hossein Rezaeian, San Mateo, CA (US); Vijayalakshmi Krishnamurthy, Sunnyvale, CA (US)

(73) Assignee: Oracle International Corporation, Redwood Shores, CA (US)

(21) Appl. No.: 18/825,949

(22) Filed: Sep. 5, 2024

(51) Int. Cl. G06F 16/332; G06F 16/2452; G06F 16/2453

(52) U.S. Cl. CPC G06F 16/3325; G06F 16/24522; G06F 16/24532; G06F 16/3329

(57) ABSTRACT

In some embodiments, a system generates a first query to be executed on a first data repository and a second query to be executed on a second data repository based on an initial user query using a first LLM, executes the first query on the first data repository to generate a first set of results, executes the second query on the second data repository to generate a second set of results, merges the first and second sets of results using a second LLM to form a merged set of results, selects a subset of the merged set of results based on a comparison of the merged set of results to the initial user query, generates a prompt based on the initial user query and the subset of the merged set of results, and submits the prompt to a third LLM to generate a response to the initial user query.

### TECHNICAL FIELD

The present disclosure relates to retrieval augmented generation (RAG). In particular, the present disclosure relates to a RAG architecture that performs search and retrieval over different types of data.

### BACKGROUND

Retrieval-augmented generation (RAG) is an artificial intelligence framework that combines generative large language models (LLMs) with information retrieval systems. This natural language processing technique is commonly used to make LLMs more accurate, relevant, and up to date. LLMs can understand, summarize, generate, and predict new content. However, LLMs can still be inconsistent and fail at some knowledge-intensive tasks, such as tasks that are outside of their initial training data or those tasks that require up-to-date information. By retrieving information from sources other than training data, the quality of LLM responses improves. Retrieving information from these other sources enables the LLM to access current information that it was not used to train the LLM.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system implementing a RAG architecture in accordance with one or more embodiments;

FIG. 2 illustrates an example set of operations for performing search and retrieval over different types of data in a RAG architecture in accordance with one or more embodiments;

FIG. 3 illustrates an example set of operations for ingesting different types of data for use in performing search and retrieval over different types of data in a RAG architecture in accordance with one or more embodiments; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. RAG ARCHITECTURE
3. SEARCH AND RETRIEVAL OVER DIFFERENT TYPES OF DATA
4. COMPUTER NETWORKS AND CLOUD NETWORKS
5. HARDWARE OVERVIEW
6. MISCELLANEOUS; EXTENSIONS

### 1. General Overview

The present disclosure describes techniques for implementing a RAG architecture that can perform automated search and retrieval over different types of data. RAG architecture augments the capabilities of an LLM by adding an information retrieval system that provides grounding data. However, such an approach has many limitations if the data is structured (e.g., tabular) and the foundation LLM model was not trained to properly handle a query on structured data. In a RAG system with semantic search, one first vectorizes the text, and then indexes the vectors and stores them in a vector store for retrieval. Incoming queries are also vectorized in the same fashion. Documents retrieved are those that are closest to the query in the embedding space. Then, those retrieved documents are rank based on their relevance to the query and then the system passes the most relevant retrieved results to the LLM as context for the response generation. This approach works for unstructured data. However, when we are dealing with semi-structured data or structured data or mixed, the similarity search based retrieval approach is not effective for Structured Query Language (SQL) tables.

One or more embodiments use an LLM to determine what types of queries to use for document retrieval in a RAG architecture. In some embodiments, a system, in response to receiving an initial user query, uses a first LLM to generate a first query of a first query type (e.g., a vector-based query) for executing on a first data repository of a first repository type (e.g., a repository for unstructured data, such as a vector store) and to generate a second query of a second query type (e.g., an SQL query) for executing on a second data repository of a second repository type (e.g., a repository for structured data, such as an SQL database) based on the initial user query. The system executes the first query on the first data repository to generate a first set of results and executes the second query on the second data repository to generate a second set of results. The system merges the first set of results and the second set of results, and then selects a subset of the merged results based on a comparison of the merged results with the initial user query. Next, the system generates a prompt based on the initial user query and the selected subset of the merged results. The system then submits the prompt to a third LLM to generate a response to the initial user query.

One or more embodiments provide a unique way of processing ingested data for storage in their respective data repositories for use in the RAG architecture. When a document having semi-structured data (e.g., structured data, such as a table, included amongst unstructured data) is ingested into the system, the system typically converts the structured data into unstructured data, and then performs an embedding operation on the unstructured data to generate a corresponding vector, which the system stores in a vector data store. However, the amount of structured data may be so large as to create an excessively heavy workload on the system. Therefore, in order to address this problem and more efficiently process documents having semi-structured data, the system may determine if the structured data in the document satisfies a minimum threshold amount of data (e.g., are there more than 1000 cells in the table). If the structured data does not satisfy the minimum threshold amount of data, then the system converts the structured data into unstructured data, executes an embedding operation to generate a vector corresponding to the unstructured data, and stores the vector corresponding to the unstructured data in the vector data store. However, if the structured data satisfies the minimum threshold amount of data, then the system stores the structured data in an SQL database, thereby avoiding the excessively heavy workload associated with the conversion/embedding process.

One or more embodiments described in this Specification and/or recited in the claims may not be included in this General Overview section.

### 2. Rag Architecture

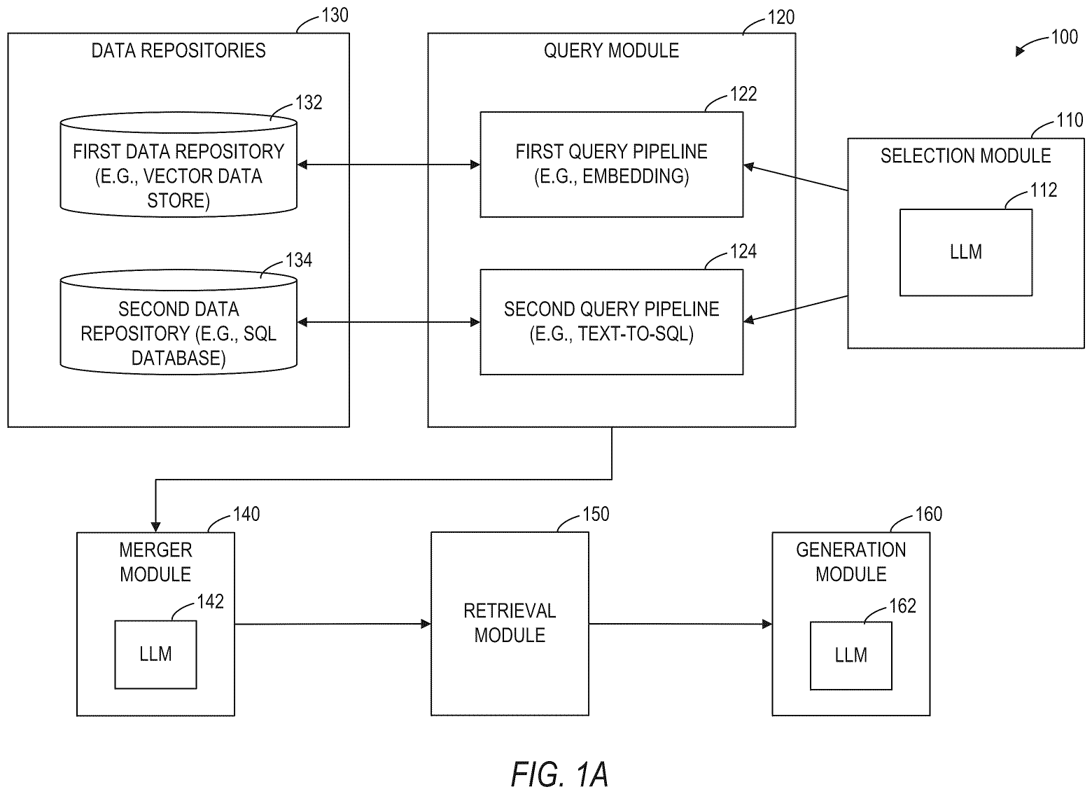

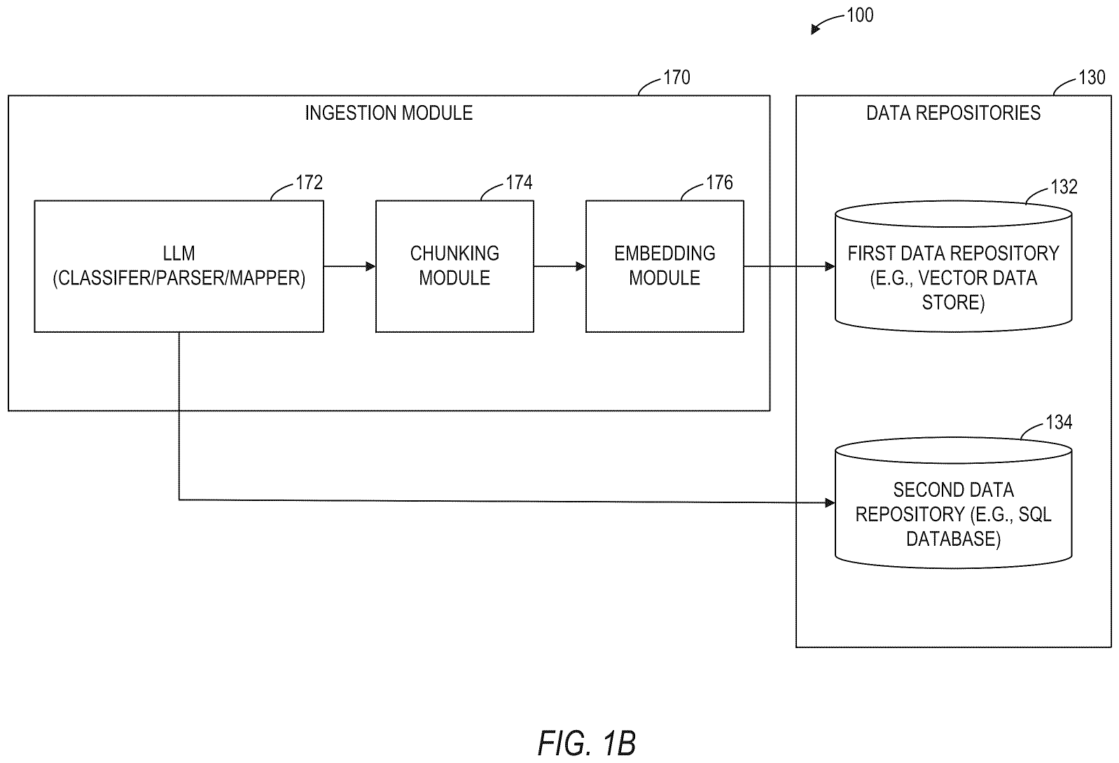

FIGS. 1A and 1B illustrate a system 100 implementing a RAG architecture in accordance with one or more embodiments. FIG. 1 illustrates components of the system 100 that are used to perform search and retrieval over different types of data in a RAG architecture, and FIG. 1B illustrates components of the system 100 that are used to process ingested data for storage in their respective data repositories for use in the RAG architecture. As illustrated in FIGS. 1A-1B, in some embodiments, system 100 includes a selection module 110, a query module 120, data repositories 130, a merger module 140, a retrieval module 150, a generation module 160, and an ingestion module 170. The system 100 may include more or fewer components than the components illustrated in FIGS. 1A-1B. The components illustrated in FIGS. 1A-1B may be local to or remote from each other. The components illustrated in FIGS. 1A-1B may be implemented in software and/or hardware. Each component may be distributed over multiple applications and/or machines. Multiple components may be combined into one application and/or machine. Operations described with respect to one component may instead be performed by another component.

The components of the system 100 may communicate with one another via one or more computer networks. Furthermore, one or more components of the system 100 may be implemented as part of a cloud network. Additional embodiments and/or examples relating to computer networks are described below in Section 4, titled “Computer Networks and Cloud Networks.”

In some embodiments, the data repositories 130 of the system 100 are any type of storage unit and/or device (e.g., a file system, database, collection of tables, or any other storage mechanism) for storing data. Further, the data repositories 130 of the system 100 may include multiple different storage units and/or devices. The multiple different storage units and/or devices may or may not be of the same type or located at the same physical site. In an embodiment, the data repositories 130 comprise a first data repository 132 of a first type of data repository and a second data repository 134 of a second type of data repository different from the first type of data repository. For example, the first data repository 132 may comprise a vector data store that stores unstructured data and the second data repository 134 may comprise an SQL database that stores structured data. Other configurations of the data repositories 130 are within the scope of the present disclosure.

Referring to FIG. 1A, in an embodiment, the system 100 is configured to use the selection module 110 and the query module 120 to generate a plurality of different types of queries based on an initial user query. In one or more embodiments, the selection module 110 is configured to determine a plurality of different types of queries for an initial user query. The selection module 110 may be configured to receive the initial user query from a computing device of a user. The selection module 110 may access the initial user query in other ways as well. The initial user query may comprise a natural language prompt. A natural language prompt is natural language text that describes a task to be performed by a computer system. Other types of input for the initial user query are also within the scope of the present disclosure.

In some embodiments, the selection module 110 comprises an LLM 112 that is configured to determine different types of queries to generate and execute for the initial user query. The LLM 112 may be a fine-tuned classifier that uses a self-criticism prompting, chain-of-thought prompting, and reflection. Self-criticism prompting is a technique that helps LLMs to improve their logic and reasoning by evaluating, refining, and verifying their own outputs. This technique transforms the traditional process of question-answering into a dynamic, iterative cycle of evaluation and improvement. Self-criticism works by having a model critique its initial outputs before returning the final response. Chain-of-thought prompting is a prompt engineering technique that aims to improve language models'performance on tasks requiring logic, calculation and decision-making by structuring the input prompt in a way that mimics human reasoning. Reflection is a feature that allows an executing program to examine or introspect upon itself, and manipulate internal properties of the program.

In one or more embodiments, the selection module 110 is configured to access metadata of the data repositories 130, such as metadata that describes the type of data stored in each of the data repositories 130. The selection module 110 may be configured to input the metadata, along with the initial user query, into the LLM 112 to determine what types of queries to generate and execute for the initial user query. For example, based on the metadata of the data repositories 130 and the initial user query, the selection module 110 may determine two types of queries to generate and execute for the initial user query: a vector query (e.g., a vector search) to be executed on the vector data store of the first data repository 132 and an SQL query to be executed on the SQL database of the second data repository 134.

In an embodiment, the selection module 110 is configured to invoke the corresponding query pipeline for each type of query determined by the LLM 112 for the initial user query. In some embodiments, the query module 120 is configured to execute the corresponding query pipeline for the different types of queries. For example, the query module 120 may execute a first query pipeline for a first type of query determined by the LLM 112 for the initial user query and a second query pipeline for a second type of query determined by the LLM 112 for the initial user query. If the first type of query is a vector query, then the query module 120 may execute an embedding operation as part of the first query pipeline 122 to generate a corresponding vector for the initial user query, and then execute the vector query on the vector data store of the first data repository 132. If the second type of query is an SQL query, then the query module 120 may execute a text-to-SQL algorithm to convert the initial user query into the SQL query, and then execute the SQL query on the SQL database of the second data repository 134. Other configurations of the types of queries determined by the LLM 112 and the corresponding query pipelines executed by the query module 120 are within the scope of the present disclosure.

The execution of the different query pipelines generates corresponding set of results. For example, the query module 120 may execute the first query pipeline to generate a first set of results, and the query module 120 may execute the second query pipeline to generate a second set of results. The query pipelines for the different types of queries may be performed in parallel. For example, the first query pipeline and the second query pipeline may be executed in parallel.

In one or more embodiments, the merger module 140 is configured to merge the different sets of results generated via the different query pipelines executed by the query module 120. In some embodiments, the merger module 140 comprises an LLM 142 that is configured to combine the different set of results. For example, the merger module 140 may use the LLM 142 to combine a first set of results generated by a vector query executed by the query module 120 and a second set of results generated by an SQL query executed by the query module 120.

In some embodiments, the retrieval module 150 is configured to select a subset of the merged set of results based on a comparison of the merged set of results to the initial user query. The retrieval module 150 may be configured to perform post-processing and re-ranking operations to select the subset of the merged set of results. For example, the retrieval module 150 may compute similarity measurements between the merged set of results and the initial user query, such as based on cosine similarity, and then select the results that have a corresponding similarity measurement with the initial user query that satisfies a minimum threshold for inclusion in the subset of the merged set of results. In an embodiment, the retrieval module 140 is configured to rank the subset of the merged set of results based on the similarity measurements.

In one or more embodiments, the generation module 160 is configured to generate a prompt based on the subset of merged set of results provided by the retrieval module 150 and the initial user query. For example, the generation module 160 may use a set of rules or a model generate the prompt. The prompt may include the subset of merged set of results and the initial user query. In some embodiments, the generation module 160 is further configured to submit the prompt to an LLM 162 to generate a response to the initial user query. The LLM 162 may be configured to generate a response to the initial user query based on the prompt. The LLM 162 may use refine or compact generation methods in generating the response to the initial user query.

In an embodiment, the generation module 170 is configured to present the response to the initial user query on a computing device of a user, such as on the computing device via which the user submitted the initial user query. The generation module 170 may display the response on the computing device or present the response in audio format on the computing device. Other ways of presenting the response are also within the scope of the present disclosure.

Referring to FIG. 1B, in one or more embodiments, the ingestion module 170 is configured to process ingested documents having semi-structured data in an efficient way that avoids an excessive workload on the system 100. The ingestion module 170 may execute an extract, transform, and load (ETL) process on documents to store data of the documents in the data repositories 130. In some embodiments, the ingestion module 170 comprises an LLM 172, a chunking module 174, and an embedding module 176.

In one or more embodiments, the LLM 172 is configured to function as a data parser, a data classifier, and a mapper. The data parser of the LLM 172 may be configured to convert the unstructured data in a document into structured data. The data classifier of the LLM 172 may be configured to identify structured data in a document, such as any tables of data in a document. In response to structured data being identified, the LLM 172 may create metadata for the identified structured data given the context around the structured data. For example, the LLM 172 may generate metadata for tables identified in the document based on the unstructured data within a threshold distance (e.g., within a maximum number of lines or sentences from the table) from the tables in the document. The mapper of the LLM 172 may be configured to textualize the structured data extracted from the documents based on metadata of the structured data using a mapping model. In one or more embodiments, the mapping model is configured to convert the structured data of a document into unstructured data.

In an embodiments, the chunking module 174 is configured to execute a chunking algorithm on the unstructured data derived from the document. The chunking algorithm may split the unstructured data into smaller pieces called chunks. In some embodiments, the embedding module 174 is configured to execute an embedding operation on the chunks of unstructured data to generate corresponding vectors for the chunks. The ingestion module 170 may then index the vectors in one or more of the data repositories 130.

After textualization mapping by the LLM 172, the structured data (e.g., the tables) embedded in the documents can be treated in the same way as unstructured data. However, in situations in which the extracted structured data is extremely large, the LLM 172 can directly push the extracted data to the one of the data repositories 130 that stores structured data rather than one of the data repositories 130 that stores vectors. For example, if the LLM 172 determines that the structured data in the document does not satisfy a minimum threshold amount of data, then the ingestion module 170 may convert the structured data into unstructured data, execute an embedding operation to generate a vector corresponding to the unstructured data, and store the vector corresponding to the unstructured data in a vector data store of the first data repository 132. If, instead, the LLM 172 determines that the structured data satisfies the minimum threshold amount of data, then the ingestion module 170 may store the structured data in an SQL database of the second data repository 134, thereby avoiding the excessively heavy workload associated with the conversion/embedding process.

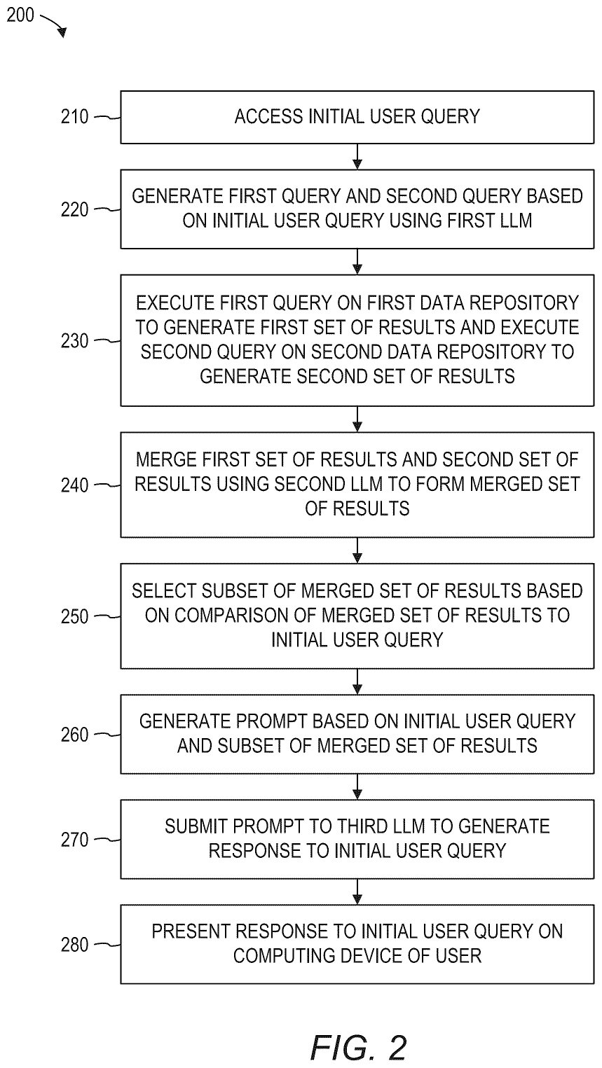

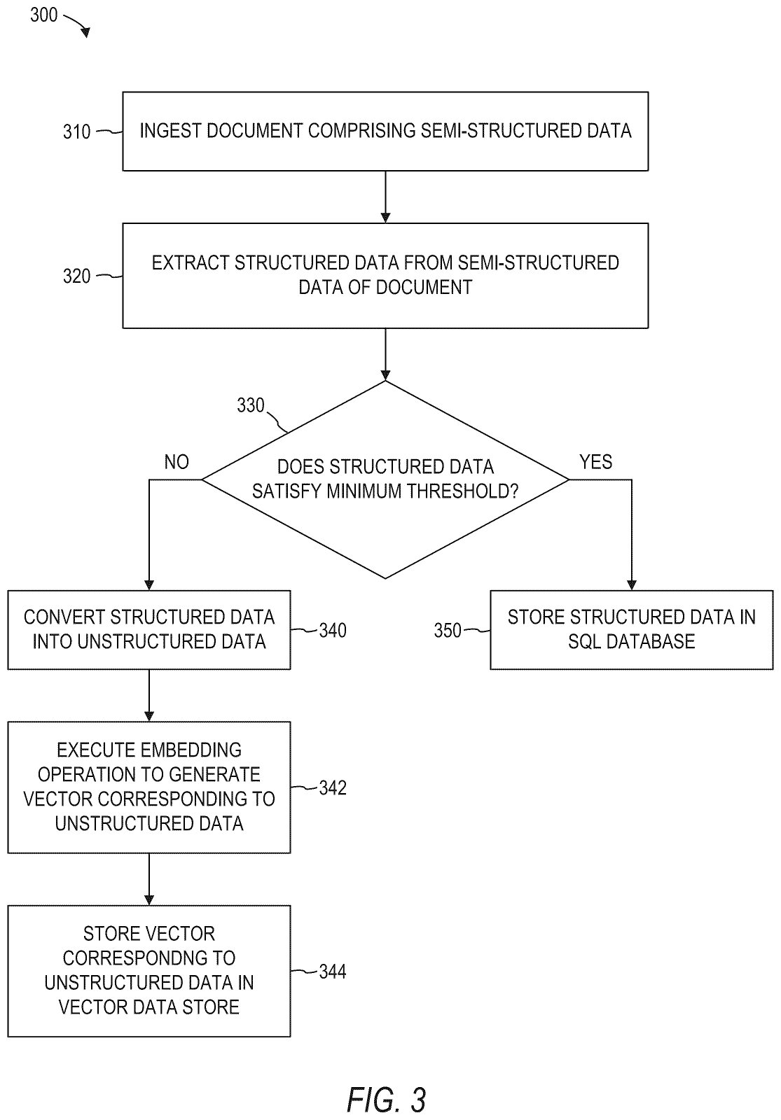

In one or more embodiments, the system 100 refers to hardware and/or software configured to perform operations described herein for search and retrieval over different types of data. Examples of operations for search and retrieval over different types of data in a RAG architecture are described below with reference to FIGS. 2 and 3.

In an embodiment, the system 100 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 3. Search and Retrieval Over Different Types of Data

FIG. 2 illustrates an example set of operations 200 for performing search and retrieval over different types of data in a RAG architecture in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

In an embodiment, the system 100 accesses an initial user query (Operation 210). The system 100 may receive the initial user query from a computing device of a user. The selection module 110 may access the initial user query in other ways as well. The initial user query may comprise a natural language prompt that has been typed, spoken, or otherwise input into the computing device of the user. Other types of input for the initial user query are also within the scope of the present disclosure.

In one or more embodiments, the system 100 generates a first query and a second query based on the initial user query using the first LLM 112 (Operation 220). The first query may be configured to be executed on a first data repository 132 of a first type of data repository. The second query may be configured to be executed on a second data repository 134 of a second type of data repository that is different from the first type of data repository. In an embodiment, the generating the first query and the second query comprises using the first LLM 112 to select the first type of query and the second type of query based on the initial user query.

In some embodiments, the first data repository 132 stores unstructured data; and the second data repository 134 stores structured data. For example, the first data repository may be a vector data store and the generating the first query may comprise executing an embedding operation to generate a first vector corresponding to text of the initial user query, while the second data repository 134 may be an SQL database and the generating the second query may comprise converting the text of the initial user query into an SQL query;

In an embodiment, the system 100 executes the first query on the first data repository 132 to generate a first set of results and executes the second query on the second data repository 134 to generate a second set of results (Operation 230). The system 100 may execute the first query and the second query in parallel. In some embodiments, the executing of the first query on the first data repository 132 comprises executing a vector search on the vector data store using the first vector; and the executing the second query on the second data repository 134 comprises executing the SQL query on the SQL database.

In an embodiment, the system 100 merges the first set of results and the second set of results using the second LLM 142 to form a merged set of results (Operation 240). The merging of the first set of results and the second set of results may comprise inputting the first set of results, the second set of results, and the initial user query into the second LLM 142. For example, the system 100 may use the LLM 142 to combine the first set of results generated by the vector query executed by the system 100 and a second set of results generated by an SQL query executed by the system 100.

In an embodiment, the system 100 selects a subset of the merged set of results based on a comparison of the merged set of results to the initial user query (Operation 250). The system 100 may be configured to perform post-processing and re-ranking operations to select the subset of the merged set of results. For example, the system 100 may compute similarity measurements between the merged set of results and the initial user query, such as based on cosine similarity, and then select the results that have a corresponding similarity measurement with the initial user query that satisfies a minimum threshold for inclusion in the subset of the merged set of results. In an embodiment, the system 100 is configured to rank the subset of the merged set of results based on the similarity measurements.

In an embodiment, the system 100 generates a prompt based on the initial user query and the subset of the merged set of results (Operation 260). For example, the system 100 may use a set of rules or a model generate the prompt. The prompt may include the subset of merged set of results and the initial user query.

In an embodiment, the system 100 submits the prompt to a third LLM 162 to generate a response to the initial user query (Operation 270). The LLM 162 may be configured to generate a response to the initial user query based on the prompt. The LLM 162 may use refine or compact generation methods in generating the response to the initial user query.

In an embodiment, the system 100 presents the response to the initial user query on the computing device of the user (Operation 280). The system 100 may display the response on the computing device or present the response in audio format on the computing device. Other ways of presenting the response are also within the scope of the present disclosure.

FIG. 3 illustrates an example set of operations 300 for ingesting different types of data for use in performing search and retrieval over different types of data in a RAG architecture in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

In an embodiment, the system 100 ingests a document comprising semi-structured data (Operation 310). The system 100 may import documents from multiple sources into a single, cloud-based storage medium for subsequent access and processing. Other ways of ingesting the document are also within the scope of the present disclosure.

In one or more embodiments, the system 100 extracts structured data from the semi-structured data of the document (Operation 320). The system 100 may use the fourth LLM 172 to extract the structured data from the semi-structured data of the document. However, in some embodiments, the system 100 may extract the structured data from the semi-structured data of the document without using an LLM.

In some embodiments, the system 100 determines if the structured data satisfies a minimum threshold amount of data (Operation 330). For example, the minimum threshold amount of data may comprise a minimum number of cells in a table of the document, such that the structured data satisfies the minimum threshold amount of data if the structured data comprises 1000 or more cells in a table. Other types of minimum threshold amounts of data are also within the scope of the present disclosure.

In an embodiment, if the system 100 determines that the structured data does not satisfy the minimum threshold amount of data, then the system 100 converts the structured data into unstructured data (Operation 340). The system 100 may use the LLM 172 to textualize the structured data based on metadata of the structured data using a mapping model. In one or more embodiments, the mapping model is configured to convert the structured data of a document into unstructured data.

Next, the system 100 may execute an embedding operation to generate a vector corresponding to the unstructured data (Operation 342). The system 100 may use a neural network to generate the vector. However, other ways of generating the vector corresponding to the unstructured data are also within the scope of the present disclosure.

In some embodiments, the system 100 then stores the vector corresponding to the unstructured data in a vector data store of the first data repository 132. The system 100 may index the vector. However, other ways of storing the vector for subsequent search are also within the scope of the present disclosure.

In an embodiment, if the system 100 determines that the structured data satisfies the minimum threshold amount of data; then the system 100 stores the structured data in an SQL database of the second data repository 134. For example, the system 100 may transmit the structured data to the second data repository 134 with an instruction to store the unstructured data in the SQL database. Other ways of storing the unstructured data in the SQL database are within the scope of the present disclosure.

The terms “first”, “second”, “third”, “fourth”, etc., should not be interpreted as requiring different elements. For example, the first LLM 112, the second LLM 142, the third LLM 182, and the fourth LLM 172 in various embodiments may be the same or different LLMs.

### 4. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally, or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 5. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

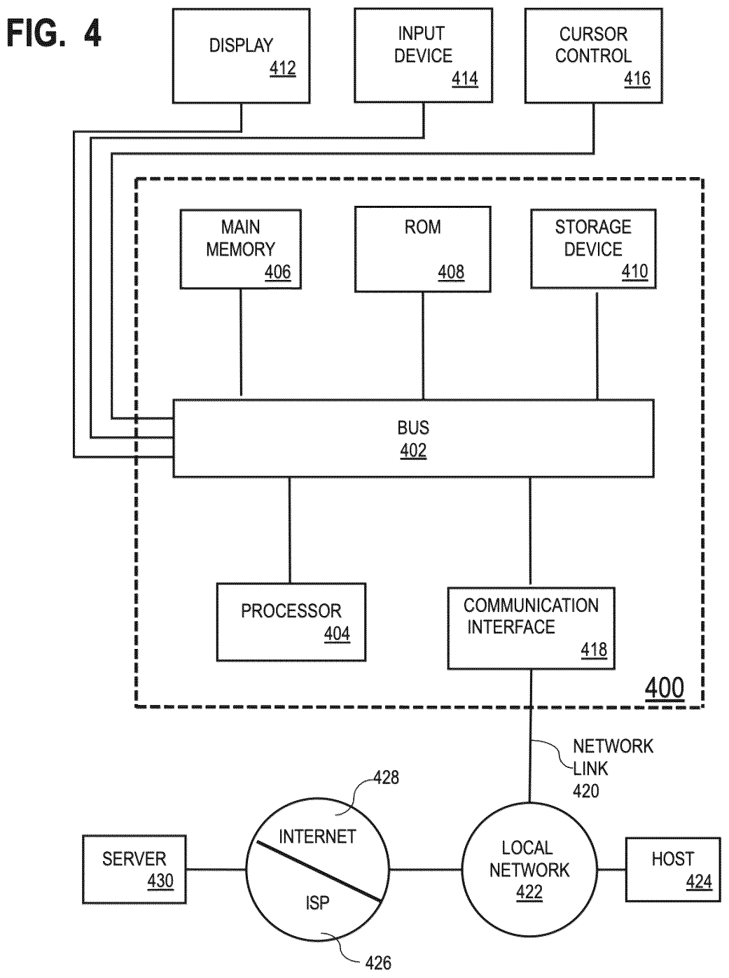

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 6. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. A method performed by at least one device including a hardware processor, the method comprising:
accessing an initial user query;
generating a first query and a second query based on the initial user query using a first Large Language Model (LLM), the first query being configured to be executed on a first data repository of a first type of data repository, the second query being configured to be executed on a second data repository of a second type of data repository, and the second data repository being of a second type of data repository different from the first type of data repository;
executing the first query on the first data repository to generate a first set of results;
executing the second query on the second data repository to generate a second set of results;
merging the first set of results and the second set of results using a second LLM to form a merged set of results;
selecting a subset of the merged set of results based on a comparison of the merged set of results to the initial user query;
generating a prompt based on the initial user query and the subset of the merged set of results;
submitting the prompt to a third LLM to generate a response to the initial user query; and
presenting the response to the initial user query on the computing device of the user.

2. The method of claim 1, wherein the initial user query comprises a natural language prompt submitted by the user via the computing device.

3. The method of claim 1, wherein the first query being a first type of query, the second query being a second type of query different from the first type of query and the generating the first query and the second query comprises using the first LLM to select the first type of query and the second type of query based on the initial user query.

4. The method of claim 1, wherein:
the first data repository stores unstructured data; and
the second data repository stores structured data.

5. The method of claim 4, wherein:
the first data repository is a vector data store;
the generating the first query comprises executing an embedding operation to generate a first vector corresponding to text of the initial user query;
the second data repository is a Structured Query Language (SQL) database;
the generating the second query comprises converting the text of the initial user query into an SQL query;
the executing the first query on the first data repository comprises executing a vector search on the vector data store using the first vector; and
the executing the second query on the second data repository comprises executing the SQL query on the SQL database.

6. The method of claim 1, wherein the executing of the first query and the executing of the second query are performed in parallel.

7. The method of claim 1, wherein the merging of the first set of results and the second set of results comprises inputting the first set of results, the second set of results, and the initial user query into the second LLM.

8. The method of claim 1, further comprising:
ingesting a document comprising semi-structured data;
extracting structured data from the semi-structured data of the document;
determining that the structured data does not satisfy a minimum threshold amount of data; and
responsive to the determination that the structured data does not satisfy the minimum threshold amount of data:
converting the structured data into unstructured data;
executing an embedding operation to generate a vector corresponding to the unstructured data; and
storing the vector corresponding to the unstructured data in a vector data store of the first data repository.

9. The method of claim 1, further comprising:
ingesting a document comprising semi-structured data;
extracting structured data from the semi-structured data of the document;
determining that the structured data satisfies a minimum threshold amount of data; and
responsive to the determination that the structured data satisfies the minimum threshold amount of data, storing the structured data in an SQL database of the second data repository.

10. One or more non-transitory computer readable media comprising instructions which, when executed by one or more hardware processors, cause performance of operations comprising:
accessing an initial user query;
generating a first query and a second query based on the initial user query using a first Large Language Model (LLM), the first query being configured to be executed on a first data repository of a first type of data repository, the second query being configured to be executed on a second data repository of a second type of data repository, and the second data repository being of a second type of data repository different from the first type of data repository;
executing the first query on the first data repository to generate a first set of results;
executing the second query on the second data repository to generate a second set of results;
merging the first set of results and the second set of results using a second LLM to form a merged set of results;
selecting a subset of the merged set of results based on a comparison of the merged set of results to the initial user query;
generating a prompt based on the initial user query and the subset of the merged set of results;
submitting the prompt to a third LLM to generate a response to the initial user query; and
presenting the response to the initial user query on the computing device of the user.

11. The media of claim 10, wherein the initial user query comprises a natural language prompt submitted by the user via the computing device.

12. The media of claim 10, wherein the first query being a first type of query, the second query being a second type of query different from the first type of query and the generating the first query and the second query comprises using the first LLM to select the first type of query and the second type of query based on the initial user query.

13. The media of claim 10, wherein:
the first data repository stores unstructured data; and
the second data repository stores structured data.

14. The media of claim 13, wherein:
the first data repository is a vector data store;
the generating the first query comprises executing an embedding operation to generate a first vector corresponding to text of the initial user query;
the second data repository is a Structured Query Language (SQL) database;
the generating the second query comprises converting the text of the initial user query into an SQL query;
the executing the first query on the first data repository comprises executing a vector search on the vector data store using the first vector; and
the executing the second query on the second data repository comprises executing the SQL query on the SQL database.

15. The media of claim 10, wherein the executing of the first query and the executing of the second query are performed in parallel.

16. The media of claim 10, wherein the merging of the first set of results and the second set of results comprises inputting the first set of results, the second set of results, and the initial user query into the second LLM.

17. The media of claim 10, wherein the operations further comprise:
ingesting a document comprising semi-structured data;
extracting structured data from the semi-structured data of the document;
determining that the structured data does not satisfy a minimum threshold amount of data; and
responsive to the determination that the structured data does not satisfy the minimum threshold amount of data:
converting the structured data into unstructured data;
executing an embedding operation to generate a vector corresponding to the unstructured data; and
storing the vector corresponding to the unstructured data in a vector data store of the first data repository.

18. The media of claim 10, wherein the operations further comprise:
ingesting a document comprising semi-structured data;
extracting structured data from the semi-structured data of the document;
determining that the structured data satisfies a minimum threshold amount of data; and
responsive to the determination that the structured data satisfies the minimum threshold amount of data, storing the structured data in an SQL database of the second data repository.

19. A system comprising:
at least one device including a hardware processor;
the system being configured to perform operations comprising:
accessing an initial user query;
generating a first query and a second query based on the initial user query using a first Large Language Model (LLM), the first query being configured to be executed on a first data repository of a first type of data repository, the second query being configured to be executed on a second data repository of a second type of data repository, and the second data repository being of a second type of data repository different from the first type of data repository;
executing the first query on the first data repository to generate a first set of results;
executing the second query on the second data repository to generate a second set of results;
merging the first set of results and the second set of results using a second LLM to form a merged set of results;
selecting a subset of the merged set of results based on a comparison of the merged set of results to the initial user query;
generating a prompt based on the initial user query and the subset of the merged set of results;
submitting the prompt to a third LLM to generate a response to the initial user query; and
presenting the response to the initial user query on the computing device of the user.

20. The system of claim 19, wherein the initial user query comprises a natural language prompt submitted by the user via the computing device.
